(19) United States
(12) Patent Application Publication
(10) Pub. No.: US 2022/0067514 A1
(43) Pub. Date: Mar. 3, 2022

(54) INFERENCE APPARATUS, METHOD, NON-TRANSITORY COMPUTER READABLE MEDIUM AND LEARNING APPARATUS

(71) Applicant: KABUSHIKI KAISHA TOSHIBA, Tokyo (JP)

(72) Inventors: Takashi IDA, Kawasaki (JP); Tenta SASAYA, Tokyo (JP); Wataru WATANABE, Tokyo (JP); Takayuki ITOH, Kawasaki (JP); Toshiyuki ONO, Kawasaki (JP)

(73) Assignee: KABUSHIKI KAISHA TOSHIBA, Tokyo (JP)

(21) Appl. No.: 17/181,101

(22) Filed: Feb. 22, 2021

(30) Foreign Application Priority Data
Aug. 26, 2020 (JP) 2020-142879

(51) Int. Cl. G06N 3/08; G06N 3/04; G06F 17/18; G06F 7/22

(52) U.S. Cl. CPC G06N 3/08; G06F 7/22; G06F 17/18; G06N 3/0481

(57) ABSTRACT

According to one embodiment, an inference apparatus includes a processor. The processor generates an intermediate signal by processing an input signal with a convolutional neural network. The processor extracts one or more intermediate partial signals each serving as part of the intermediate signal from the intermediate signal. The processor calculates a statistic of the one or more intermediate partial signals. The processor outputs an inference result relating to the input signal and corresponding to the statistic.

### CROSS-REFERENCE TO RELATED APPLICATIONS

This application is based upon and claims the benefit of priority from Japanese Patent Application No. 2020-142879, filed Aug. 26, 2020, the entire contents of which are incorporated herein by reference.

### FIELD

Embodiments described herein relate to an inference apparatus, method, a non-transitory computer readable medium and a learning apparatus.

### BACKGROUND

In an image classification field, such as intruder detection based on an image of a security camera and product anomaly detection, discrimination processing with a neural network has been adopted. Specifically, the discrimination processing with a neural network is used for the purposes of discrimination processing, such as detection of an intruder showing in a little size in an image photographed with a security camera and detection of a small defect of a product from an appearance inspection image in a factory.

In generally adopted discrimination processing with a neural network, when the discrimination processing is executed for an image with a large number of pixels, the image size is reduced in the first half of convolution processing. For this reason, the resolution of the image is reduced, and the discrimination accuracy deteriorates. In addition, generation of an interest map requires additional processing as well as detection processing, and the processing quantity and/or delay causes the problem in a situation in which acquisition of discrimination processing result is required in a short time. In addition, there is the problem that the interest map is insufficient as grounds for identification, because the interest map does not appear in the process of discrimination processing.

### BRIEF DESCRIPTION OF THE DRAWINGS

FIG. 1 is a block diagram illustrating an inference apparatus according to a first embodiment;

FIG. 2 is a flowchart illustrating an operation example of the inference apparatus according to the first embodiment;

FIG. 3 is a diagram illustrating an example of image data acquired by imaging a product;

FIG. 4 is a diagram illustrating an example of image data acquired by imaging a product to which a foreign substance adheres;

FIG. 5 is a diagram illustrating an example of image data acquired by imaging a product in a state in which a position of the product is shifted in an imaging area;

FIG. 6 is a diagram illustrating an example of partial images extracted from the image data of the product;

FIG. 7 is a diagram illustrating a first example of convolution processing in a convolution processing unit according to the first embodiment;

FIG. 8 is a diagram illustrating a second example of convolution processing in the convolution processing unit according to the first embodiment;

FIG. 9 is a conceptual diagram illustrating an operation example of the inference apparatus according to the first embodiment, with an image serving as an example;

FIG. 10 is a diagram illustrating a first modification of an output unit;

FIG. 11 is a diagram illustrating a second modification of the output unit;

FIG. 12 is a diagram illustrating a third modification of the output unit;

FIG. 13 is a diagram illustrating an example of image data acquired by imaging the product;

FIG. 14 is a schematic diagram illustrating an example of an intermediate partial image;

FIG. 15 is a diagram illustrating an example of preprocessing of an interest map;

FIG. 16 is a diagram illustrating an example of superimposed display of an input image and the interest map;

FIG. 17 is a conceptual diagram of an operation example of the inference apparatus according to a modification of the first embodiment;

FIG. 18 is a flowchart illustrating an operation example of an inference apparatus according to a second embodiment;

FIG. 19 is a conceptual diagram illustrating an operation example of the inference apparatus according to the second embodiment, with an image serving as an example;

FIG. 20 is a diagram illustrating an example of using a one-dimensional signal as an input signal;

FIG. 21 is a diagram illustrating convolutional processing in a convolutional processing unit according to a third embodiment;

FIG. 22 is a block diagram illustrating a learning system including a learning apparatus according to a fourth embodiment; and

FIG. 23 is a diagram illustrating an example of hardware configuration of the inference apparatus and the learning apparatus.

### DETAILED DESCRIPTION

In general, according to one embodiment, an inference apparatus includes a processor. The processor generates an intermediate signal by processing an input signal with a convolutional neural network. The processor extracts one or more intermediate partial signals each serving as part of the intermediate signal from the intermediate signal. The processor calculates a statistic of the one or more intermediate partial signals. The processor outputs an inference result relating to the input signal and corresponding to the statistic.

An inference apparatus, method, a non-transitory computer readable medium and a learning apparatus according to the present embodiment will now be explained in detail hereinafter with reference to drawings. In the following embodiments, elements denoted by the same reference numerals execute the same operations, and an overlapping explanation thereof will be omitted.

### First Embodiment

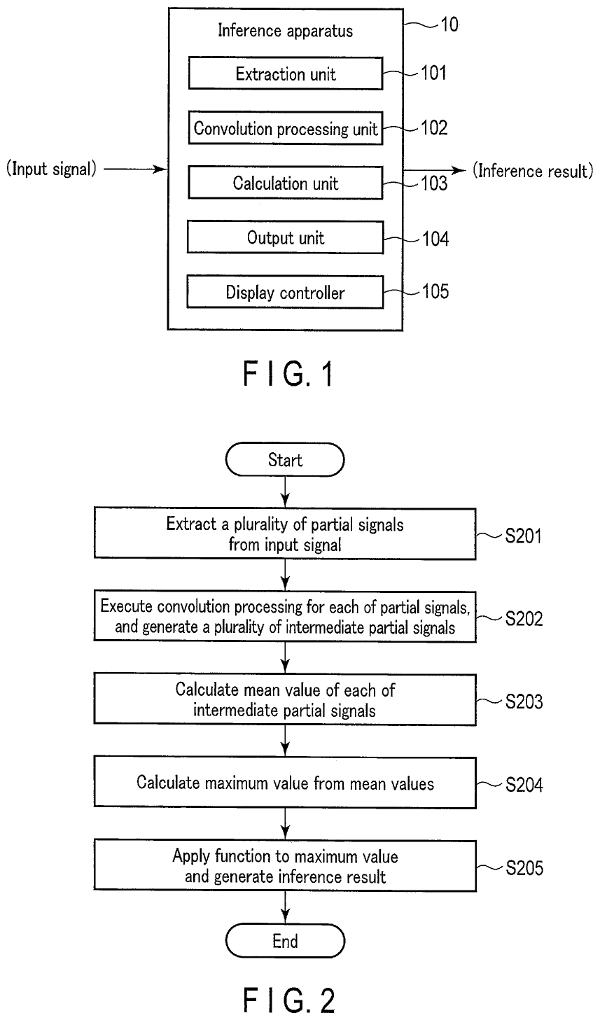

An inference apparatus according to a first embodiment will be explained with reference to a block diagram of FIG. 1.

An inference apparatus 10 according to the first embodiment includes an extraction unit 101, a convolution processing unit 102, a calculation unit 103, an output unit 104, and a display controller 105.

The extraction unit 101 receives an input signal. The input signal is, for example, an image signal. The image signal may be a still image, or a moving image including a predetermined number of time-series images. As another example, the input signal may be a one-dimensional time-series signal. The one-dimensional time-series signal is, for example, a sound signal and/or an optical signal acquired for a predetermined time.

The extraction unit 101 extracts one or more partial signals each of which is a different part in the input signal. For example, when the input signal is a still image, the partial signal is a partial image acquired by extracting a predetermined part in the still image. The partial signals may have the same size or different sizes. When the extraction unit 101 extracts a plurality of partial signals from the input signal, the extraction unit 101 may extract partial signals overlapping the other partial signals, or extract partial signals not overlapping the other partial signals.

The convolution processing unit 102 includes a convolutional neural network including a layered structure including a plurality of convolution layers. The convolution processing unit 102 receives a plurality of partial signals from the extraction unit 101, and processes each of the partial signals with the convolutional neural network to generate one or more intermediate partial signals corresponding to the one or more partial signals.

A plurality of convolution processing units 102 may be provided to correspond to a plurality of partial signals extracted with the extraction unit 101 by one-to-one correspondence. When a plurality of convolution processing units 102 are provided, convolutional neural networks included in the respective convolution processing units 102 may have the same parameters or parameters different from each other, such as the weight coefficient and the bias value. Only one convolution processing unit 102 may be provided. In this case, it suffices that a plurality of partial signals are successively processed in a time-division manner.

The calculation unit 103 receives the intermediate partial signals from the convolution processing unit 102, and executes statistical processing for the intermediate partial signals to calculate a statistic.

The output unit 104 receives the statistic from the calculation unit 103, and outputs an inference result relating to the input signal and corresponding to the statistic.

The display controller 105 executes emphasis processing corresponding to the statistic for the intermediate partial signals, and superimposes and displays the emphasized intermediate partial signals as an interest map on at least one of the input signal and the partial signals. The display controller 105 is illustrated as part of the inference apparatus 10, but the structure is not limited to it. The display controller 105 may be a member separated from the inference apparatus 10.

The following is an explanation of an operation example of the inference apparatus 10 according to the first embodiment with reference to a flowchart of FIG. 2.

At Step S201, the extraction unit 101 extracts a plurality of partial signals from the input signal.

At Step S202, the convolution processing unit 102 executes convolution processing for each of the partial signals with the convolutional neural network to generate a plurality of intermediate partial signals.

At Step S203, the calculation unit 103 calculates a statistic of the intermediate partial signals. In this example, the calculation unit 103 calculates the mean value of each of the intermediate partial signals.

At Step S204, the calculation unit 103 calculates a maximum value from the mean values.

At Step S205, the output unit 104 applies a function to the maximum value, and outputs an inference result relating to the input signal, for example, the probability that the input signal corresponds to a class of an inference target, as an inference result.

In the flowchart of FIG. 2, it is supposed to process a plurality of partial signals extracted at Step S201 at a time, but the inference apparatus 10 may process the partial signals one by one. For example, the inference apparatus 10 may extract a partial signal at Step S201, outputs an inference result for the partial signal, and thereafter extracts another partial signal to output an inference result for it.

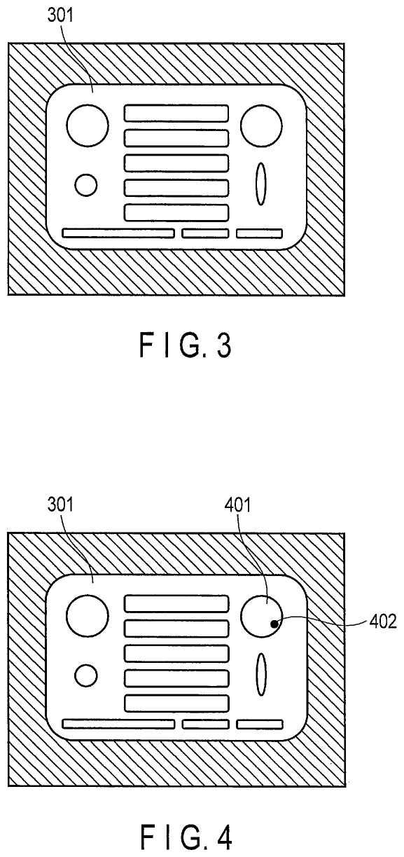

The following is an explanation of an example of the input signal supposed in the first embodiment with reference to FIG. 3 to FIG. 6. The first embodiment illustrates the case where the input signal is an image, as an example.

FIG. 3 is a diagram illustrating an example of image data acquired by imaging a product 301. The inference apparatus 10 may be used to determine presence/absence of any manufacturing defect, that is, whether the product 301 has an anomaly, in an appearance inspection for the product 301 in a manufacturing line in a factory. In this case, the inference apparatus 10 acquires image data acquired by imaging the product 301 as illustrated in FIG. 3, as the input signal. The image data acquired by imaging the product 301 is, for example, a monochrome image of visible light, a color image, or an infrared image, an X-ray image, or a depth image acquired by measuring projections and depressions.

FIG. 4 is a diagram illustrating image data acquired by imaging the product 301 to which a foreign substance 402 adheres. For example, as illustrated in FIG. 4, when an anomaly exists in the appearance of the product 301, such as the case where the foreign substance 402 adheres to a circular component 401, the inference apparatus 10 determines that the product 301 is “defective”. When no anomaly exists in the appearance of the product 301, the inference apparatus 10 determines that the product 301 is “not defective”.

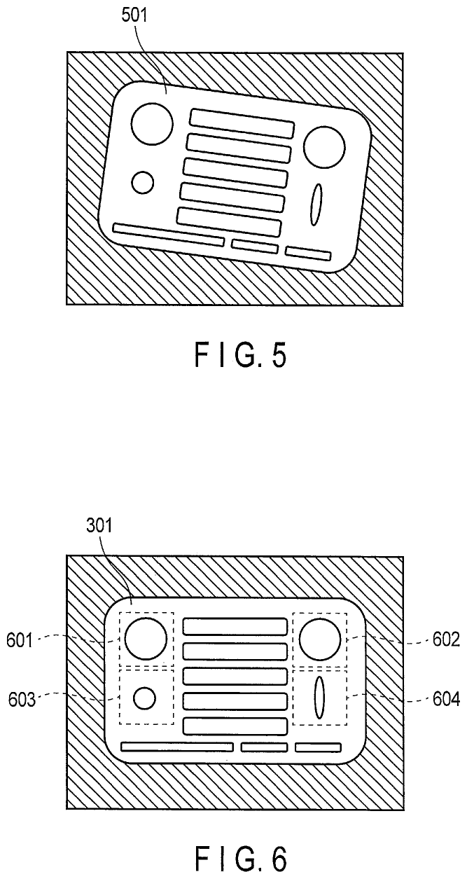

FIG. 5 is a diagram illustrating image data acquired by imaging a product 501 in a state in which a position of the product 501 is shifted in an imaging area. If images with equal pixel values can be ideally captured for all the normal products, it suffices that a difference in pixel value between the normal product image and the captured image is simply calculated and it is determined that the captured image has a defect when the image includes any part having the larger absolute value. However, actually, there are cases where even the image of a normal product often includes fluctuations, such as the case where the position of the product 501 is shifted as illustrated in FIG. 5, the case where the illumination intensity and/or the image sensor sensitivity fluctuates, and the case where positions of the components are shifted within a range not exceeding the tolerance. In such cases, presence/absence of defects cannot be determined on the basis of a simple difference. The inference apparatus 10 according to the present embodiment uses a neural network to include these fluctuating images in training data in advance, and is capable of dealing with them in inference processing.

FIG. 6 illustrates an example of a plurality of partial signals included in the input image, that is, partial images. In an appearance inspection of the product 301 in the manufacturing line in the factory, the inference apparatus 10 extracts predetermined partial images in the image data acquired by imaging the product 301, and infers presence/absence of anomaly in the partial images.

For example, the extraction unit 101 extracts four partial images, that is, partial images 601, 602, 603, and 604 having the same size, such as rectangular parts each enclosed with broken lines in FIG. 6. Each of positions of the partial images 601, 602, 603, and 604 can be determined in advance according to parts serving as inspection targets. For example, regions to which components are attached in the previous step of the appearance inspection may be set as partial images. The extraction unit 101 may extract any number of partial images, or extract a plurality of partial images having different sizes or shapes.

Although detection of a foreign substance is easier in partial images having similar image patterns, such as the partial image 601 and the partial image 602, it is possible to process partial images having different image patterns due to a difference in shape, such as the partial image 603 and the partial image 604. This is because learning is possible in learning of the neural network described later to prevent the apparatus from reacting a difference in image pattern as a defect. This structure enables the inference apparatus 10 to process the extracted partial images together.

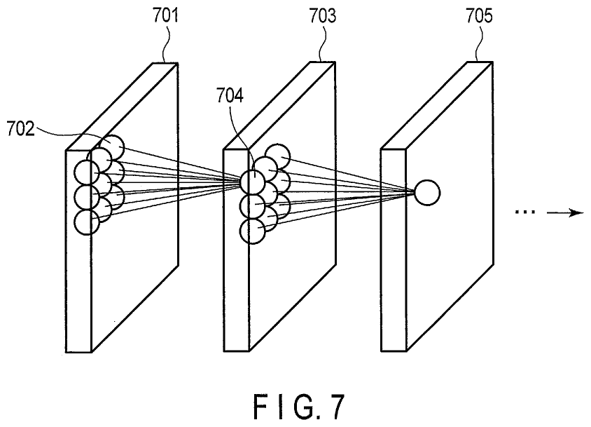

The following is an explanation of a first example of convolution processing in the convolution processing unit 102 with reference to FIG. 7.

FIG. 7 is a schematic diagram illustrating a partial image 701 for one channel serving as a partial signal, and intermediate partial images serving as intermediate partial signals generated by convolution processing with the convolution processing unit 102. For the sake of convenience of explanation, each of pixels (also referred to as “sampling data”) 702 of the partial image 701 is illustrated with a sphere, and suppose that each of pixels 702 has a pixel value. In the first convolution layer in a plurality of convolution layers forming the convolutional neural network, a weight coefficient included in the kernel (also referred to as “filter”) and the pixel value of the pixel 702 of the partial image of a region corresponding to the kernel are subjected to a product-sum operation in each of pixels 702 of the partial image 701. In this manner, a pixel value is calculated for one pixel 704 of an intermediate partial image 703 serving as an intermediate partial signal.

In the example of FIG. 7, the weight coefficient corresponding to each of nine regions of a kernel having a 3×3 size is multiplied by each of pixel values of nine pixels 702 formed of 3×3 pixels in length and breadth corresponding to the regions of the kernel in the partial image, and the multiplication values are added to calculate a pixel value of one pixel 704. Thereafter, the kernel is moved horizontally and vertically, and a similar product-sum operation is executed for each of the adjacent pixel positions to generate the intermediate partial image 703 for one channel. Thereafter, in the subsequent convolution layer, convolution processing is executed for the intermediate partial image 703 to generate an intermediate partial image 706. Thereafter, in each of the convolution layers forming the convolutional neural network, similar convolution processing for the intermediate partial image is executed.

The kernel is supposed to be moved by one pixel (that is, one stride). In an end portion of the partial image 701 for which a convolutional operation is performed and the subsequent intermediate partial image 703, the peripheral pixels are secured in a larger size by performing zero padding or copying pixel values of the end portion. This structure maintains the size of the intermediate partial image input to the subsequent convolution layer at the original partial image size without changing the number of vertical pixels and the horizontal pixels, even when a convolutional operation is performed by a stride. Specifically, the number of pieces of sampling data in the intermediate partial image (intermediate partial signal) is the same as that in the partial image (partial signal).

In addition to a product-sum operation, a predetermined bias value may be added to the sum of products. The bias value may be fixed for the whole image space in the same manner as the weight coefficient.

In addition, an activation layer may be inserted between layers of a plurality of convolution layers. The activation layer executes activation processing by applying a predetermined function, such as ReLU (Rectified Linear Unit), to the intermediate partial image 703 serving as the output from the convolution layer and acquired by a product-sum operation and addition of the bias value.

The activation layer is not always applied after the convolution layer. Specifically, a pattern in which convolution layers are successively connected without an activation layer interposed therebetween and a pattern in which an activation layer is connected after the convolution layer may exist in a mixed manner.

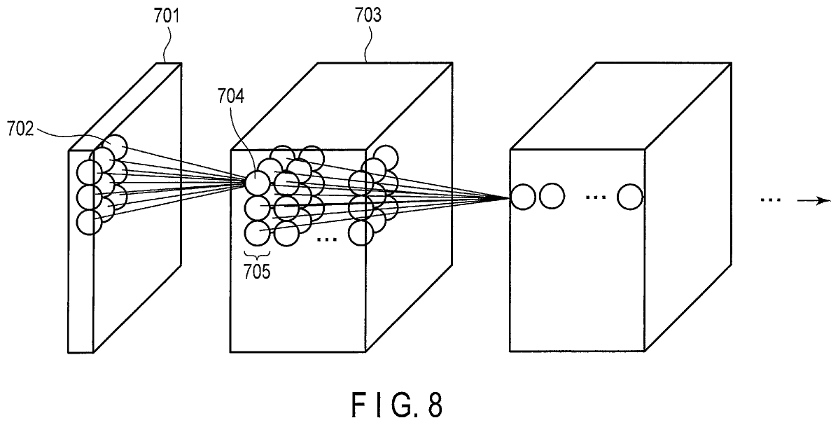

The following is an explanation of a second example of the convolution processing with the convolution processing unit 102 with reference to FIG. 8.

The intermediate partial image 703 generated with the convolution layer may be formed with a plurality of channels. For example, in the case of a color image, the intermediate partial image 703 is an image of three channels corresponding to RGB signals. A convolution layer including a plurality of channels has a higher degree of freedom of processing, and is capable of dealing with various images. The example of FIG. 8 is supposed to include the intermediate partial image 703 including a plurality of channels 705, and the intermediate partial image 703 is subjected to convolution processing for each of the channels 705. To maintain the resolution of the image, the number of vertical pixels and the number of horizontal pixels in the intermediate partial image 703 are not changed. Because the number of pieces of data is equal to “vertical pixels×horizontal pixels×channels”, when the memory quantity of the hardware achieving the inference apparatus 10 is limited, the number of channels should be set within the limit.

In addition, the weight coefficients and the bias values of the kernel used for the channels are different between the channels. Specifically, even when the position of the kernel is the same, that is, even when the position of the pixel is the same in the intermediate partial image 703 including a plurality of channels, the pixel values are different.

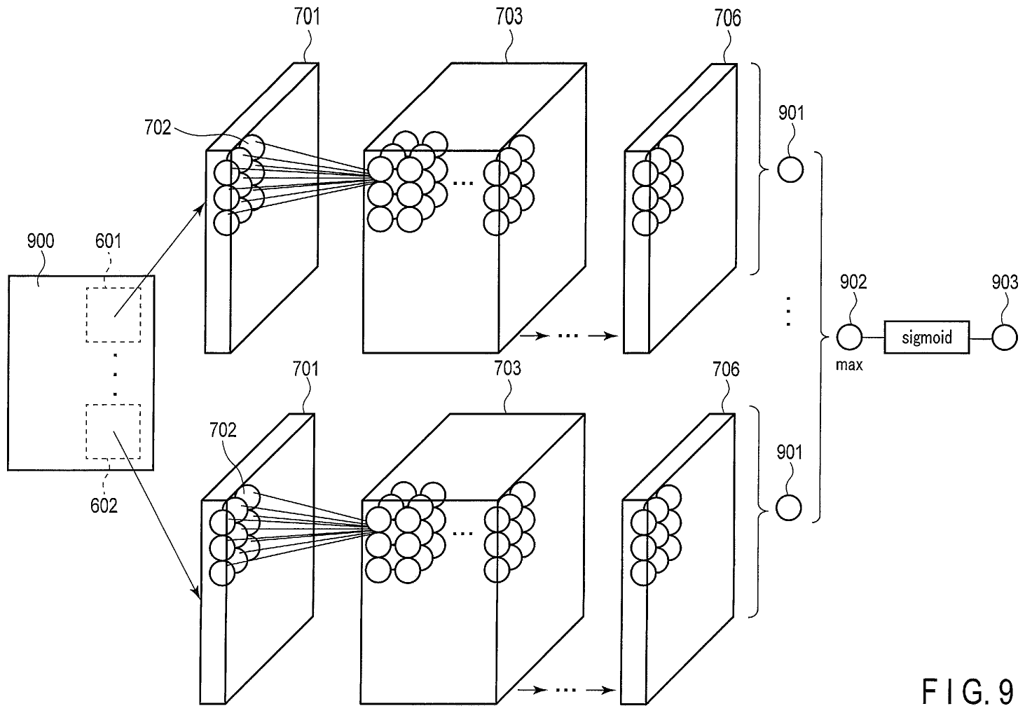

The following is an explanation of an operation example of the inference apparatus 10 according to the first embodiment illustrated in FIG. 2, with reference to the conceptual diagram of FIG. 9.

FIG. 9 is a diagram illustrating a series of flows of partial image extraction processing for the input image in the extraction unit 101, convolution processing in the convolution processing unit 102, calculation processing in the calculation unit 103, and inference result output processing with the output unit 104.

The extraction unit 101 extracts a partial image 601 and a partial image 602 from an input image 900 serving as the identification target.

The convolution processing unit 102 executes convolution processing for each of the partial image 601 and the partial image 602 using the convolutional neural network. In the last layer of the convolutional neural network, that is, the last convolution layer generating an output from the convolution processing unit 102, the output is designed to be have one channel. As illustrated in FIG. 9, when the convolution layer directly before the last convolution layer is the intermediate partial image 703 including a plurality of channels, the kernel of a channel is applied to the channels and addition is performed to generate an intermediate partial image 706 of one channel. As another example, the intermediate partial image 706 of one channel may be generated by calculating the sum or the weighted sum of the channels in the last convolution layer.

The calculation unit 103 calculates the mean value 901 of pixels of the intermediate partial image 706 acquired with the convolution processing unit 102. Specifically, one mean value 901 is calculated from one intermediate partial image 706. The calculation unit 103 calculates the maximum value 902 in the calculated mean values 901. The calculation unit 103 is not limited to calculation of the mean value, but may select the maximum pixel value in the pixels of the whole intermediate partial image 706 as the maximum value 902.

The output unit 104 applies a function to the maximum value 902. In this example, a sigmoid function is applied to the maximum value 902 to output an inference result 903. The inference result 903 is, for example, the probability that the input image 900 has a defect. By applying the sigmoid function, the output value has a value between zero to one. For this reason, when the output value is output as it is, the output value indicates the probability that the input image has a defect. As another example, the value “0.5” may be set as the threshold, and a result of binary determination may be output as the inference result 903. For example, a result “a defect exists” (“defective”) is output when the output value based on the sigmoid function is equal to or higher than the threshold, and a result “no defect exists” (“not defective”) is output when the output value based on the sigmoid function is smaller than the threshold.

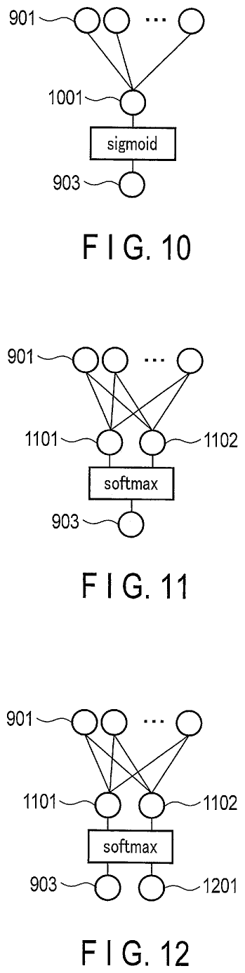

FIG. 10 illustrates a first modification of the output unit 104.

As illustrated in FIG. 10, instead of applying a sigmoid function to the maximum value 902 of the mean values 901 of the respective intermediate partial images 706, a sigmoid function may be applied to a value 1001. The value 1001 is acquired by addition of values acquired by multiplying a weight coefficient by the mean values 901 of the intermediate partial images 706 calculated with the calculation unit 103, that is, full connection. The output from the output unit 104 according to the first modification is generated as an inference result 903 indicating the probability of defect.

FIG. 11 illustrates a second modification of the output unit 104.

In FIG. 11, a plurality of outputs acquired by full connection of the mean values 901 as illustrated in FIG. 10 may be set, and a softmax function may be applied to the outputs. For example, a first input 1101 and a second input 1102 may be input to the softmax function, and the probability of “defective” may be output as the inference result 903.

FIG. 12 illustrates a third modification of the output unit 104.

An input to the softmax function is similar to that of the second modification illustrated in FIG. 11, but a plurality of outputs may be output from the softmax function in the third modification. Specifically, as illustrated in FIG. 12, in addition to the inference result 903 relating to the probability of “defective”, an inference result 1201 may be output simultaneously. The inference result 1201 relates to the probability of “not defective” acquired by subtracting the probability of “defective” from 1.

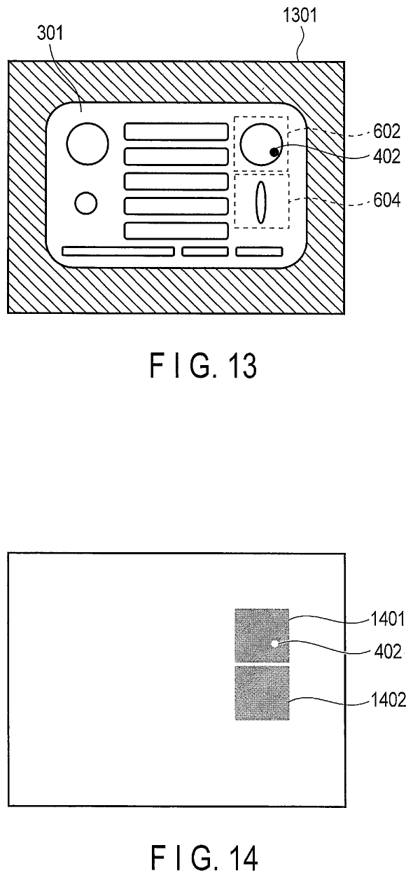

The following is an explanation of a display example of an interest map serving as the grounds for the inference result acquired by the inference apparatus 10, with reference to FIG. 13 to FIG. 16.

The intermediate partial image acquired in the process of the inference processing with the inference apparatus 10 and serving as the source of the mean value selected as the maximum value can be used as an interest map relating to defects without any processing.

For example, FIG. 13 illustrates an input image 1301 serving as an identification target and acquired by imaging the product 301 in the same manner as FIG. 3. Suppose that a foreign substance 402 exists in a partial image 602 of the product 301, and an inference result “defective” in the product 301 is acquired due to the foreign substance 402 in the inference apparatus 10.

FIG. 14 illustrates a schematic diagram of an intermediate partial image 1401 corresponding to the partial image 602 inferred as “defective”. In FIG. 14, a white region indicates a region having a large pixel value, and a region with a color close to black indicates a region having a small pixel value.

As illustrated in FIG. 14, the intermediate partial image 1401 corresponding to the partial image 602 is supposed to have a large pixel value in the region of the foreign substance 402 and often have a small pixel value in the region other than the foreign substance 402. This is because, when the intermediate partial image 1401 includes a region having a large pixel value due to a defect such as a foreign substance, the mean value of the luminance values of the intermediate partial image also increases, the maximum value also increases, and consequently the intermediate partial image is inferred as “defective” with high probability.

By contrast, because an intermediate partial image 1402 corresponding to the partial image 604 includes no foreign substance, the pixel value is uniformly small in the region of the intermediate partial image 1402. Because no defects exist inside the intermediate partial image 1402, the mean value of the luminance values of the intermediate partial image decreases, the maximum value thereof also decreases, and consequently the possibility that the intermediate partial image is inferred as “defective” decreases.

Accordingly, by displaying the intermediate partial image generated with the inference apparatus 10 as the interest map in association with the input image, the user is enabled to check the partial image inferred as “defective”.

The position information (coordinate information) of the partial image for the input image may be provided to the partial image as a label or the like, and may be attached to the intermediate partial image as it is even when the partial image is processed with the convolution processing unit 102. As another example, the calculation unit 103 may receive the position information of the partial image, and associate the position information with the intermediate partial image serving as the output from the convolution processing unit 102.

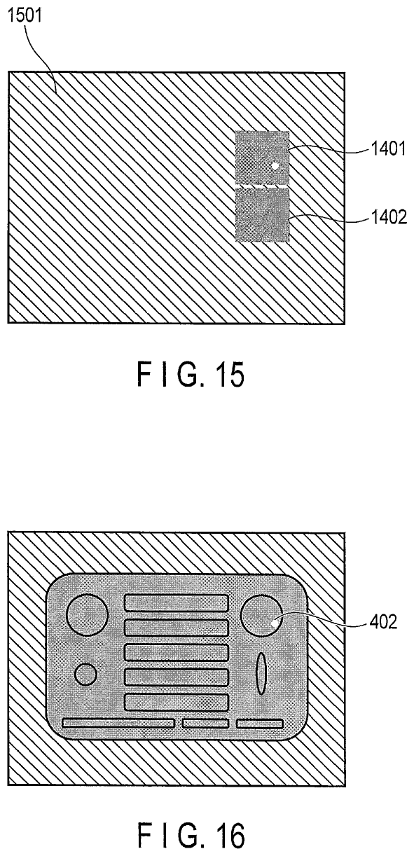

FIG. 15 illustrates an example of preprocessing of the interest map. A base image 1501 with a small pixel value set for the whole region is prepared, and the intermediate partial image 1401 and the intermediate partial image 1402 are superimposed on the base image 1501 on the basis of the position information extracted from the input image.

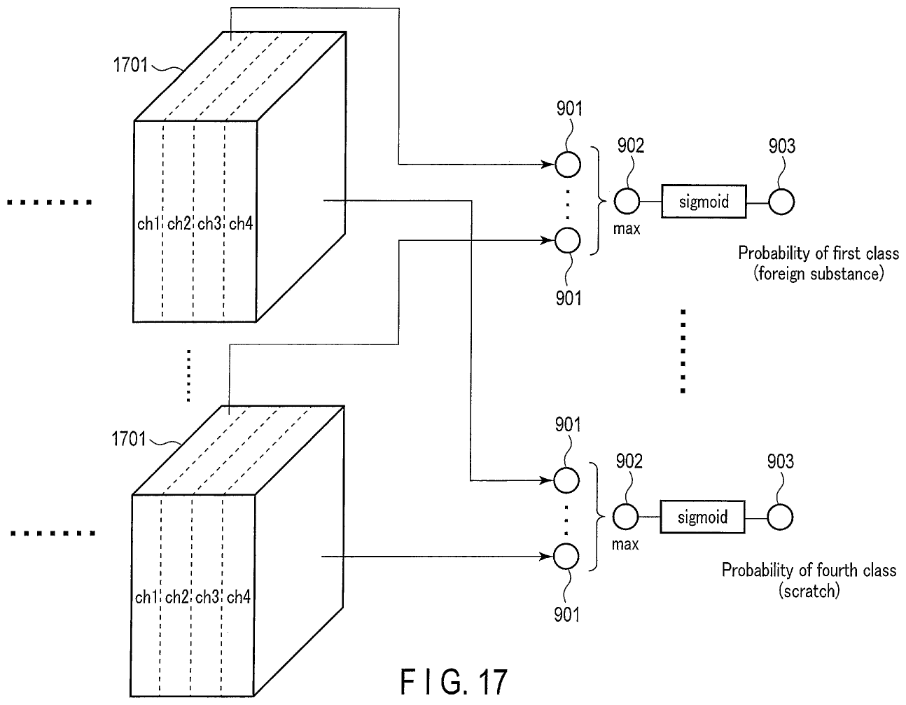

FIG. 16 illustrates an example of superimposed display of the input image and the interest map.

In FIG. 16, an image is displayed. In the image, the pixel value of the input image and the pixel value of the interest map are averaged for each of the pixels. This enables generation of a check image to check a defect by the user. In the check image, because only the part of the foreign substance 402 has a large pixel value, the part has a larger pixel value than the pixel values of the other region, and displayed in white color in the example of FIG. 16. This structure enables the user to easily recognize the part serving as the grounds for the inference result.

The check image described above may be displayed on an external display device when the display controller 105 receives an instruction to display the interest map or the check image from the user. As another example, when an inference result “defective” is acquired, the check image may be displayed on the external display device. When the display controller 105 is a unit separated from the inference apparatus 10, the interest map may be transmitted from the inference apparatus 10 to the display controller 105, and processing to display the interest map and the check image may be executed.

As another example, the display controller 105 may execute processing of coloring the foreign substance 402 with a color that is not used in the input image according to the pixel value of the interest map to further highlight the foreign substance 402 on the image. As another example, the display controller 105 may display a mark, such as an arrow, indicating the region of the foreign substance 402 or cause the region of the foreign substance to blink to enable the user to easily recognize the defect. As another example, the display controller 105 may perform control to display a message “defective” or the like. As another example, the display controller 105 may perform control to display the region including the foreign substance part in an enlarged state in response to the user's click or touch on the region around the defect in the image illustrated in FIG. 16.

Specifically, any method may be used as long as the display mode is a mode enabling emphasis display of the intermediate partial image as the interest map with the display controller 105.

According to the first embodiment described above, partial images are extracted, and a convolutional operation is executed for each of the partial images. This structure prevents rapid reduction in image size, enables a convolutional operation while the resolution of the image is maintained, and enables acquisition of high discrimination accuracy. In addition, even when the original image has a large size, the image is processed in partial images acquired by extracting parts of the image. This structure has a merit that increase in the processing quantity and/or required memory quantity is prevented even when the resolution is maintained, without decreasing the resolution.

In addition, because the intermediate partial image is acquired by extracting a part of the image and subjected to a convolutional operation without changing the image size, the intermediate partial image can be used as the interest map without any processing. This structure removes the necessity for processing of generating an interest map separately, unlike the conventional art. In addition, because presence/absence of defects can be directly recognized on the basis of the pixel value in the intermediate partial image serving as the interest map, the grounds for identification are clear even when a neural network is used. As a result, the inference apparatus according to the first embodiment enables achievement of classification processing with high accuracy.

### Modification of First Embodiment

The first embodiment illustrates one-class classification of presence/absence of defects. In a modification of the first embodiment, the inference apparatus 10 executes multi-class classification of executing classification into a plurality of classes as inference targets. The multi-class classification in the present modification is supposed to execute identification of the type of the defect, such as adhesion of a foreign substance, deformation of the component, and scratches, for example, in a defection inspection.

An operation example of the inference apparatus 10 according to the modification of the first embodiment will be explained hereinafter with reference to the conceptual diagram of FIG. 17.

In FIG. 17, the processing before the last layer of the convolution layers generating the output from the convolution processing unit 102 is the same as that in FIG. 9, and an explanation thereof is omitted herein.

Intermediate partial images 1701 illustrated in FIG. 17 are intermediate partial images output from the last layer of the convolutional neural network of the convolution processing unit 102. Although two intermediate partial images are illustrated as an example, intermediate partial images of a number corresponding to the number of extracted partial images are generated, in the same manner as the first embodiment.

The number of channels of each of the intermediate partial images 1701 output from the last layer of the convolutional neural network is not one but set to the same number as the number of classes to be classified by inference processing. In this example, because it is supposed to execute four-class classification, the intermediate partial images 1701 each having four channels (a first channel Ch1, a second channel Ch2, a third channel Ch3, and a fourth channel Ch4) are generated.

The calculation unit 103 calculates the mean value 901 of the pixel values of each intermediate partial image 1701 for each of the channels, and calculates a statistic based on the intermediate partial images 1701 for each of the channels.

In the example of FIG. 17, the calculation unit 103 calculates the mean values 901 of the pixel values for the first channel Ch1 of the intermediate partial images 1701, and outputs the maximum value 902 in the selected mean values 901.

The output unit 104 applies a sigmoid function to the maximum value of the first channel Ch1 to generate an inference result of the first class. For example, the output unit 104 outputs the probability of presence/absence of a foreign substance as an inference result of the first class.

In the same manner, for the intermediate images from the second channel to the fourth channel, the output unit 104 outputs the probabilities of the second class to the fourth class as the inference results. The output unit 104 may prepare a plurality of functions to separately output inference results for the respective classes in accordance with the number of classes, or apply one function a plurality of times to output inference results of the respective classes.

Each of the modifications described above according to the first embodiment may be applied to the calculation unit 103 and the output unit 104.

According to the modification of the first embodiment described above, an output of the last layer of the convolutional neural network in the convolution processing unit is set to be intermediate partial images each having a plurality of channels. The inference apparatus calculates a statistic for each of the channels in the same manner as the first embodiment, and outputs inference results of classes in accordance with the statistics. This structure achieves classification including classes of the number corresponding to the number of channels, that is, multi-class classification.

### Second Embodiment

The second embodiment is different from the first embodiment in that extraction processing with the extraction unit 101 is executed for the output of the last layer of the convolutional neural network.

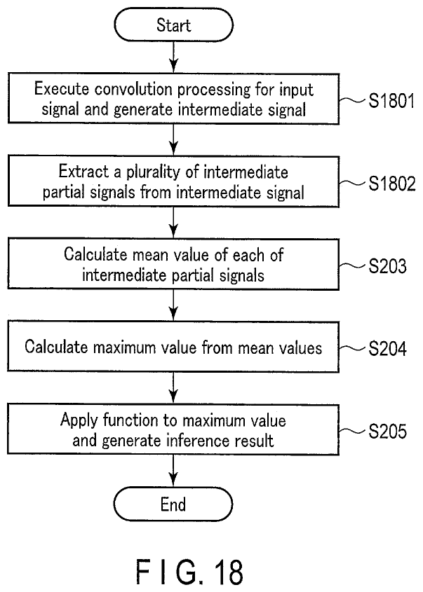

An operation example of the inference apparatus according to the second embodiment will be explained hereinafter with reference to the flowchart of FIG. 18.

At Step S1801, the convolution processing unit 102 executes convolution processing for the input signal with the convolutional neural network to generate an intermediate signal.

At Step S1802, the extraction unit 101 extracts a plurality of intermediate partial signals from the intermediate signal. With respect to the positions at which the intermediate partial signals are extracted, because the input to the convolutional neural network is an input signal, the method for extracting partial signals from the input signal described in the first embodiment is applicable, and intermediate partial signals can be extracted from the intermediate signal in the same manner.

Processing from Step S203 to Step S205 is the same as that in FIG. 2, and an explanation thereof is omitted. In the same manner as the first embodiment, the inference apparatus 10 may process the partial signals one by one.

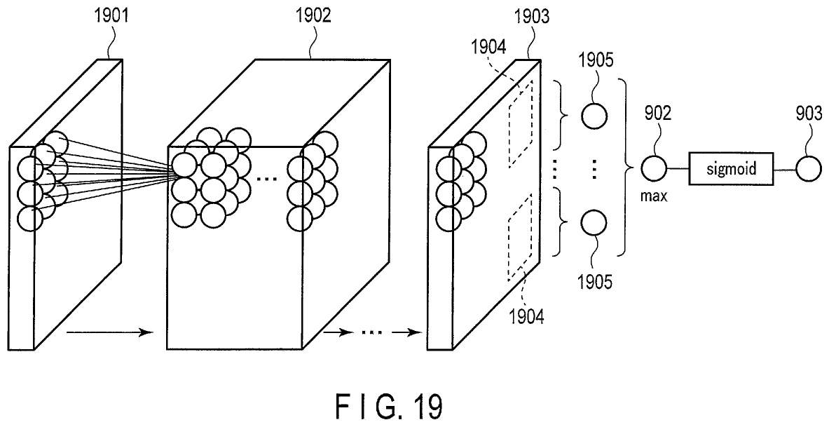

The following is an explanation of an operation example of the inference apparatus according to the second embodiment illustrated in FIG. 18, with an image serving as an example, with reference to FIG. 19.

FIG. 19 illustrates a series of flows of inference processing for an input image 1901, in the same manner as FIG. 9.

The convolution processing unit 102 executes convolution processing using the convolutional neural network for the input image 1901 to generate an intermediate image 1902. FIG. 19 illustrates an example of the intermediate image 1902 including a plurality of channels, but the intermediate image 1902 may be an intermediate image including one channel. In the same manner as the first embodiment, convolution processing is executed for each of the channels, and it suffices that the processing is performed to acquire an intermediate image 1903 of one channel at the last layer of the convolutional neural network.

The extraction unit 101 receives the intermediate image 1903 from the convolution processing unit 1902, and extracts a plurality of intermediate partial images 1904 from the intermediate image 1903.

The calculation unit 103 calculates mean values 1905 of the respective intermediate partial images 1904, and calculates the maximum value 902 in the mean values 1905.

The output unit 1904 applies a sigmoid function to the maximum value 902 and outputs, for example, the probability of “defective” as the inference result 903, in the same manner as the first embodiment.

According to the second embodiment described above, the inference apparatus subjects the input signal to convolution processing with the convolutional neural network, and executes extraction processing for an intermediate signal output from the last layer of the convolutional neural network to generate intermediate partial signals. Even when the timing of extraction processing is different, classification processing with high accuracy is achieved in the same manner as the first embodiment.

In the first embodiment and the second embodiment, the extracted image including the whole defect enables easier detection of the defect. By contrast, when the extracted image is too large, information other than the defect relatively increases, and causes difficulty in detection of the defect. For this reason, when the size of the defect can be expected in advance, the size of the extracted image may be set in accordance with the size of the defect. For example, the magnification of the extraction size may be set, such as the size twice or four times as large as the size of the defect lengthwise and breadthwise. Specifically, it suffices that the extraction unit 101 receives information relating to the size of the defect, for example, from the external device, and extracts partial images in the first embodiment, intermediate partial images in the second embodiment, in a size acquired by multiplying the set magnifications of the extraction size by the size of the defect. This structure is expected to improve the detection accuracy.

### Third Embodiment

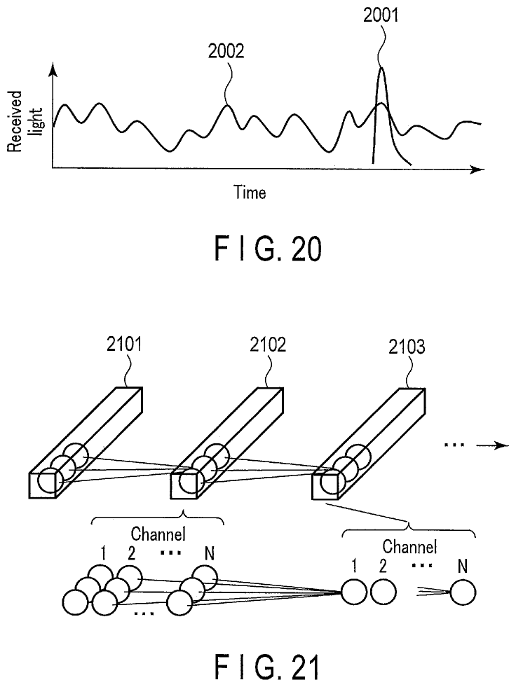

The third embodiment illustrates the case of using a one-dimensional signal as the input signal with reference to FIG. 20.

FIG. 20 illustrates change with a lapse of time in received light in a distance measurement apparatus measuring a distance to the object on the basis of the time from application of a laser pulse to the object to reception of the light reflected from the object. In the graph in FIG. 20, the vertical axis indicates the intensity of the received light, and the horizontal axis indicates the time.

When a pulse 2001 to be measured is specified, ambient light 2002, such as sunlight, other than the pulse 2001 is mixed as a noise, and the measurement accuracy may deteriorates.

The inference processing with the inference apparatus 10 is also applicable to such distance measurement with a distance measurement apparatus. Convolution processing in the convolution processing unit for a one-dimensional signal will be explained hereinafter with reference to the conceptual diagram of FIG. 21.

The extraction unit 101 extracts a plurality of partial signals from the input signal acquired by sampling the received light. For example, it suffices that the extraction unit 101 extracts partial signals 2101 at predetermined time intervals. The example of FIG. 21 illustrates sampling points of the received light with spheres.

The convolution processing unit 102 executes one-dimensional convolution for the partial signal 2101. Specifically, the convolution processing unit 102 applies a one-dimensional kernel to the partial signal 2101, and executes a product-sum operation for the sampling values of the partial signal 2101 and the weight coefficient to generate an intermediate partial signal 2102. In the example of FIG. 21, it suffices that the intermediate partial signal 2102 is generated by applying a kernel of 1×3 size to three signal values to generate a sampling value of the subsequent layer, and successively applying the kernel to the subsequent three sampling values by, for example, one stride. It suffices that the convolution processing unit 102 successively executes convolution processing. For example, the convolution processing unit 102 thereafter executes convolution processing for the partial signal 2102 in the same manner to generate an intermediate partial signal 2103.

Although it is not illustrated, the calculation unit 103 calculates the mean values of the intermediate partial signal for the output from the convolution processing unit 102 in the same manner as the case of an image, and calculates the maximum value in the mean values. The output unit 104 can detect the probability that the position (time) of the partial signal at which the intermediate partial signal serving as the origin of the calculated maximum value is extracted is the position of the pulse, as the inference result.

When the input signal is a signal including a plurality of channels, it suffices that the convolution processing unit 102 executes convolution processing for the one-dimensional signal including a plurality of channels, for each of the channels, and executes processing such that the input signal is changed to data of one channel at the last layer of the convolutional neural network, in the same manner as the case of an image according to the first embodiment.

The third embodiment described above achieves classification processing with high accuracy even when the input signal is a one-dimensional signal, in the same manner as the case where the input signal is an image.

### Fourth Embodiment

The fourth embodiment illustrates a learning apparatus learning the convolution neural network included in the inference apparatus 10 explained in the first embodiment to the third embodiment.

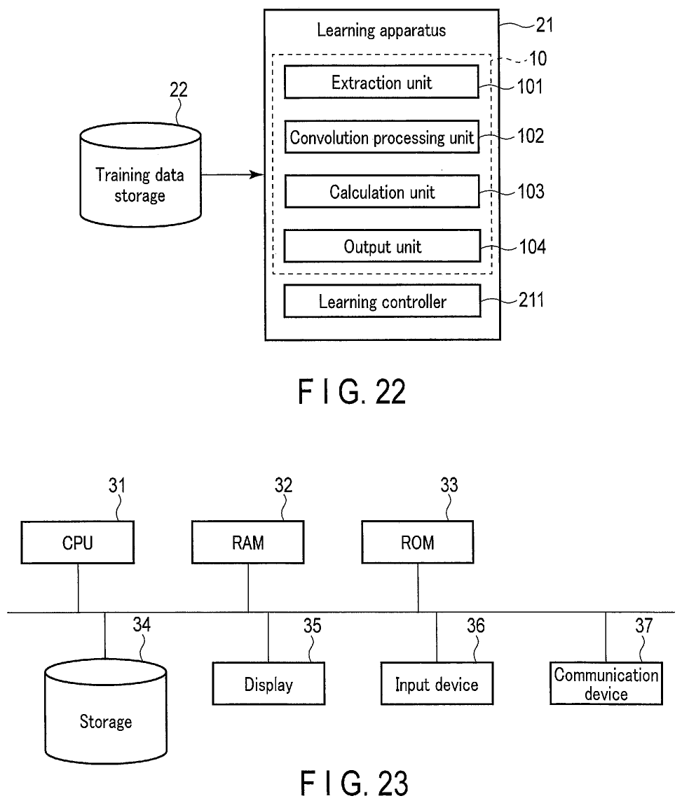

A learning system including the learning apparatus according to the fourth embodiment is illustrated in the block diagram of FIG. 22. The learning system includes a learning apparatus 21 and a training data storage 22. The learning apparatus 21 includes an extraction unit 101, a convolution processing unit 102, a calculation unit 103, an output unit 104, and a learning controller 211. When learning is finished, the inference apparatus 10 described above in the first embodiment to the third embodiment and including the extraction unit 101, the convolution processing unit 102, the calculation unit 103, and the output unit 104 is achieved. For the sake of convenience of explanation, FIG. 22 illustrates the learning apparatus 21 including the structure of the inference apparatus 10, but the structure is not limited thereto. Learning may be executed by connecting the inference apparatus 10 serving as a unit separated from the learning apparatus 21 with the learning apparatus 21.

The training data storage 22 stores therein training data to train the inference apparatus 10, specifically, train the convolutional neural network included in the inference apparatus 10. The training data is sample data with a correct label (teaching data). For example, when the training data is training data for a defect inspection, training data should be formed of pairs each formed of a normal product image and a correct label (for example, “0”) of a classification result indicating that the product is normal, or pairs each formed of an anomaly product image and a correct label (for example, “1”) of a classification result indicating that the product is anomaly.

The learning controller 211 calculates an error between the inference result output from the output unit 104 when the training data is input to the inference apparatus 10 and the correct label of the training data. Specifically, for example, suppose that the probability of “defective” is output as the inference result from the output unit 104. The probability of “defective” and the probability of “not defective” acquired by subtracting the probability of “defective” from 1 are expressed with a vector. For example, the output unit 104 outputs a vector (the probability of “defective”, the probability of “not defective”) as the inference result for the image of the input training data.

By contrast, the vector of the correct label of the training data is expressed as “(1, 0)” in the case of “defective”, and as “(0, 1)” in the case of “not defective”. The learning controller 211 calculates an error between the vector output from the output unit 104 and the vector of the correct label by, for example, cross entropy.

The learning controller 211 updates and optimizes the weight coefficients and the bias values by the probabilistic gradient descent method or the like, while tracing the position of the pixel used for convolution processing and the position of the data acquired as the maximum value through the network in a backward direction by the error back propagation method, and updates the parameters in the convolutional neural network until the training is finished. The same method as that used in ordinary training processing can be used as the machine learning method in the neural network, such as the error back propagation method, and a specific explanation thereof is omitted.

In the case of multi-class classification, it suffices that the vector of the correct label is expressed as a one-hot vector including a vector element corresponding to the class number. For example, training data includes pairs each formed of an anomaly product image and a correct label being a one-hot vector in which the element of the class indicating the type of the anomaly is set to 1 and the elements of the other classes are set to 0. Specifically, vectors (scratch, adhesion of a foreign substance, and deformation of the component) acquired by classifying the types of anomaly into three types are set as correct labels, when a product image includes a scratch by visual observation, a pair of the product image and a correct label of the vector (1, 0, 0) in which the element indicating a scratch is set to 1 and the other elements are set to 0 is set as training data. When the product image includes a plurality of types of anomaly, the training data may be a vector in which all the elements of the corresponding types are set to 1.

The learning controller 211 calculates an error between the vector having the dimensions corresponding to the number of types of anomaly and output from the output unit 104 in the case where the product image of the training data is input to the inference apparatus 10 and the correct label of the training data for each of the elements of the types of anomaly.

The fourth embodiment described above achieves the inference apparatus according to the first embodiment to the third embodiment for each of the partial images, by learning the convolutional neural network with training data provided with a correct label for an input signal.

For example, in a neural network in which each part of an image is simply extracted and presence/absence of anomaly is independently inspected for each part, it is required to set presence/absence of anomaly of each part as correct data and prepare pieces of correct data for the number of parts. By contrast, in the training data in the fourth embodiment, for example, intermediate partial images of partial images for the input image are integrated after convolution processing, and classification is executed for the whole input image as to whether an anomaly exists in any part of the original input image. For this reason, it suffices that one correct label is provided to the image. This structure enables easy preparation of correct data by visual observation.

FIG. 23 illustrates an example of hardware configuration of the inference apparatus 10 and the learning apparatus 21 according to the embodiments described above.

The inference apparatus 10 and the learning apparatus 21 include a CPU (Central Processing Unit) 31, a RAM (Random Access Memory) 32, a ROM (Read Only Memory) 33, a storage 34, a display 35, an input device 36, and a communication device 37 that are connected with a bus.

The CPU 31 is a processor executing arithmetic processing and control processing and the like in accordance with programs. The CPU 31 executes various types of processing in cooperation with the programs stored in the ROM 33 and the storage 34 and the like, with a predetermined region of the RAM 32 used as the working area.

The RAM 32 is a memory, such as a SDRAM (Synchronous Dynamic Random Access Memory). The RAM 32 functions as a working area for the CPU 31. The ROM 33 is a memory storing programs and various types of information therein in an unrewritable manner.

The storage 34 is a device of writing and reading data to and from a magnetic recording medium, such as an HDD (Hard Disk Drive), a semiconductor storage medium, such as a flash memory, a magnetically recordable storage medium, such as an HDD, or an optically recordable storage medium. The storage 34 executes writing and reading of data to and from a storage medium in response to control of the CPU 31.

The display 35 is a display device, such as an LCD (Liquid Crystal Display). The display 35 displays various types of information on the basis of a display signal from the CPU 31.

The input device 36 is an input device, such as a mouse and a keyboard. The input device 36 receives information input by a user's operation as an instruction signal, and outputs the instruction signal to the CPU 31.

The communication device 37 communicates with the external apparatus via a network in response to control of the CPU 31.

The flow charts of the embodiments illustrate methods and systems according to the embodiment. It is to be understood that the embodiments described herein can be implemented by hardware, circuit, software, firmware, middleware, microcode, or any combination thereof. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacturing including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel apparatuses, methods and computer readable media described herein may be embodied in a variety of other forms; furthermore, various omissions, substitutions and changes in the form of the apparatuses, methods and computer readable media described herein may be made without departing from the spirit of the inventions. The accompanying claims and their equivalents are intended to cover such forms or modifications as would fall within the scope and spirit of the inventions.

What is claimed is:

1. An inference apparatus comprising a processor configured to:
extract one or more partial signals each serving as part of an input signal from the input signal;
generate one or more intermediate partial signals corresponding to the one or more partial signals by processing the one or more partial signals with a convolutional neural network;
calculate a statistic of the one or more intermediate partial signals; and
output an inference result relating to the input signal and corresponding to the statistic.

2. The apparatus according to claim 1, wherein the processor calculates, as the statistic, a maximum value in mean values of the respective intermediate partial signals.

3. The apparatus according to claim 1, wherein the processor calculates, as the statistic, a maximum value in the intermediate partial signals.

4. The apparatus according to claim 1, wherein the processor calculates, as the statistic, a value acquired by full connection of mean values of the respective intermediate partial signals.

5. The apparatus according to claim 1, wherein the processor outputs the inference result by applying a function to the statistic.

6. The apparatus according to claim 5, wherein the function is a sigmoid function or a softmax function.

7. The apparatus according to claim 1, wherein
each of the intermediate partial signals is a signal including one channel, and
the inference result indicates probability that the input signal corresponds to a class serving as an inference target.

8. The apparatus according to claim 1, wherein
each of the intermediate partial signals is a signal including a plurality of channels,
the processor calculates a statistic of the intermediate partial signals for each of the channels, and
the output unit outputs, as the inference result, probabilities that the input signal corresponds to respective classes serving as inference targets and equal in number to the channels.

9. The apparatus according to claim 1, wherein number of pieces of sampling data of the intermediate partial signals is equal to that in the partial signals.

10. The apparatus according to claim 1, wherein the input signal is a one-dimensional time-series signal or an image signal.

11. The apparatus according to claim 1, the processor is further configured to:
execute emphasis processing corresponding to the statistic for the intermediate partial images; and
superimpose and display the emphasized intermediate partial signals on at least one of the input signal and the partial signals.

12. The apparatus according to claim 11, wherein the emphasis processing is coloring processing for the intermediate partial signals with a color which is set according to the statistic.

13. An inference apparatus comprising a processor configured to:
generate an intermediate signal by processing an input signal with a convolutional neural network;
extract one or more intermediate partial signals each serving as part of the intermediate signal from the intermediate signal;
calculate a statistic of the one or more intermediate partial signals; and
output an inference result relating to the input signal and corresponding to the statistic.

14. The apparatus according to claim 13, wherein number of pieces of sampling data of the intermediate signals is equal to that in the input signal.

15. An inference method comprising:
extracting one or more partial signals each serving as part of an input signal from the input signal;
generating one or more intermediate partial signals corresponding to the one or more partial signals by processing the partial signals with a convolutional neural network;
calculating a statistic of the one or more intermediate partial signals; and
outputting an inference result relating to the input signal according to the statistic.

16. A non-transitory computer readable medium including computer executable instructions, wherein the instructions, when executed by a processor, cause the processor to perform a method comprising:
extracting one or more partial signals each serving as part of an input signal from the input signal;
generating one or more intermediate partial signals corresponding to the one or more partial signals by processing the partial signals with a convolutional neural network;
calculating a statistic of the one or more intermediate partial signals; and
outputting an inference result relating to the input signal according to the statistic.

17. A learning apparatus training the convolutional neural network included in the inference apparatus according to claim 1, comprising a learning controller configured to:
calculate an error between the inference result serving as an output of the inference apparatus for the input signal and correct data associated with the input signal; and
train parameters of the convolutional neural network using the error.
